(19) United States
(12) Patent Application Publication
(10) Pub. No.: US 2012/0159219 A1
(43) Pub. Date: Jun. 21, 2012

(54) VR POWER MODE INTERFACE

(76) Inventors: Lilly Huang, Portland, OR (US); Krishnan Ravichandran, Saratoga, CA (US); Wayne L. Proefrock, Hillsboro, OR (US); Harish K. Krishnamurthy, Hillsboro, OR (US); Ruchika Singh, Portland, OR (US)

(21) Appl. No.: 12/972,666

(22) Filed: Dec. 20, 2010

(51) Int. Cl. G06F 1/26

(52) U.S. Cl. 713/323

(57) ABSTRACT

In some embodiments, a control interface and associated control entity are provided to synchronize CPU activities to CPU power delivery network such as VR mode of operation, based on CPU power demands or the prediction of actual CPU current consumption. In some embodiments, the synchronization is controlled in such timely fashion so that the power states or power-related events are entered by a CPU (or core) based on characteristics of a VR supplying power to the CPU (or core).

The present invention relates generally to power state control for computing platforms and in particular, to an interface for controlling power state changes in cooperation with a voltage regulator power mode.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram of a computing platform 101 with a VR control interface in accordance with some embodiments.

FIG. 2 is a flow diagram showing a routine for implementing a VR interface in accordance with some embodiments.

FIG. 3A is an event-timing diagram for a conventional platform.

FIG. 3B is an event-timing diagram for a platform, in accordance with some embodiments.

FIG. 4 is a diagram of a multi-core computing platform with a VR control interface in accordance with some embodiments.

### DETAILED DESCRIPTION

Computing platforms commonly use power management systems such as ACPI (the Advanced Configuration and Power Interface) to save power by operating the platform in different power states, depending on required activity, e.g., as dictated by application and external network activity. The power management system may be implemented in software (e.g., from the operating system) and/or in hardware/firmware, depending on design tastes for a given manufacturer. For example, CPU or processor cores and their associated performance levels may be regulated using so-called C and P states, respectively.

Voltage regulators (VRs) supplying power to a CPU (or core of a CPU) are typically controlled by the CPU or power control unit for the CPU to control the power mode and provided voltage level. For example, a VR may make available different operating modes to improve efficiency for different power output needs. For example, with switching regulators, which are in widespread use, phase legs may be added or decreased for higher and lower currents, respectively. They may also be operable at different switching frequencies, lower frequencies for smaller currents and higher frequencies for larger output currents.

Typically, the CPU, through one or more control signals, selects the power mode (e.g., number of active phases). However, the mode selected by the CPU is dictated and/or selected based on some “pre-defined”design specifications, not based on the actual load current that the CPU requires or consumes. It is typically selected based on the current CPU operating state (e.g., Px/Cx) or some “activity factors”. Unfortunately, this can result in the VR running at sub-optimal efficiency states than what would be necessary or sufficient for the actual current the CPU consumes. It can also lead to unnecessary transitions in the VR operation causing extra power losses and lower CPU power delivery efficiency. Another technique used by many VRs is to sense the output current locally and add or shed phases based on the actual current being drawn. However, this method is reactive and therefore requires heavy guard banding by the VR or causes performance degradation due to over stress on partial of VR components. For example, if the CPU VR senses 12A at its output, it could theoretically be running on one phase, but since the VR has no visibility into the future, it cannot take the chance and run close to the edge. So, it will likely run in 2phase mode resulting in sub-optimal efficiency.

Accordingly, in some embodiments, provided is a VR interface to dynamically correlate VR operation to actual CPU power demand, rather than merely to the operating states (e.g., Cx or Px). For example, a typical CPU VR design with discrete power components can deliver up to 15 A when only one phase is active, up to 30 A in 2-phase mode, and up to 45 A in 3-phase mode. Therefore, it is not necessary to switch to the 2-phase mode from the 1-phase mode unless CPU load consumption exceeds a certain current threshold (e.g., 15 A) and for a sufficient amount of time since most VRs can handle sporadic over-current events if the durations of power consumption are sufficiently small.

In some embodiments, a control interface and associated control entity are provided to synchronize CPU activities to CPU power delivery network such as VR mode of operation, based on CPU power demands or the prediction of actual CPU current consumption. In some embodiments, the synchronization is controlled in such a timely fashion that the power states or power-related events are entered by a CPU (or core) based on characteristics of a VR supplying power to the CPU (or core), In another word, CPU VR or CPU power delivery network can be proactively controlled and adjusted to a proper power mode or stage for the next CPU event with its associated power demand.

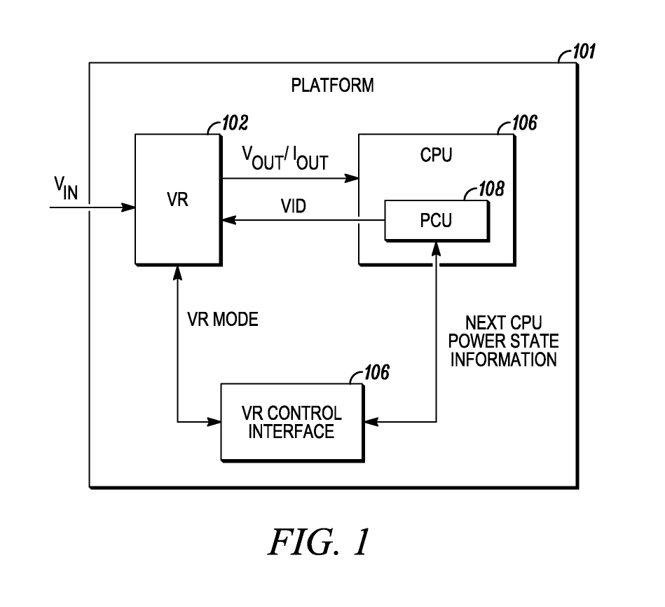

FIG. 1 is a block diagram of a computing platform 101 with a VR control interface in accordance with some embodiments. A portion of a computing platform 101 is shown. The computing platform may be any computing device that can take advantage of the principles taught herein. It could, for example, be a wireless device such as a cellular phone, notebook computer, netbook computer or tablet computer, or it could be a desktop computer, server computer or the like.

The platform 101 comprises a CPU 106, a voltage regulator (VR) 102 to supply a controllable voltage to the CPU, and a VR control interface (or VR interface) 104 to coordinate VR operating modes with CPU load demands within the context of its operating power state. The CPU could be any processing unit having one or more processing cores. It could be implemented in a separate CPU chip, or it could be a functional unit that is part of a system-on-chip type implementation.

The CPU 106 comprises a power control unit (PCU) for controlling operational CPU supply voltage and frequency based, at least in part, on a current power state for (or affecting) the CPU. The power state, e.g., an ACPI C and/or P state, may be dictated by the PCU itself, or in concert with or solely by a separate power management system, either implemented in hardware or in software such as a platform operating system (OS).

The PCU controls supply voltage by requesting a voltage from the VR, e.g., by way of a VID signal, and it receives the Voltage supply (Vout/Iout) from the VR. In prior art schemes, the PCU, in addition to providing the VID signal to the VR, would also provide to it (directly or indirectly) control signals for controlling its output power mode. These signals could include a signal for selecting a number of phases and/or a signal for operating the VR at a higher or lower switching frequency. (Switching type VR's, for example, operate more efficiently for higher currents at higher frequencies, and they not only operate more efficiently, but can actually source more current, for higher output currents.) With embodiments described herein, however, a VR interface 104 is disposed between the PCU and VR to control the VR power mode.

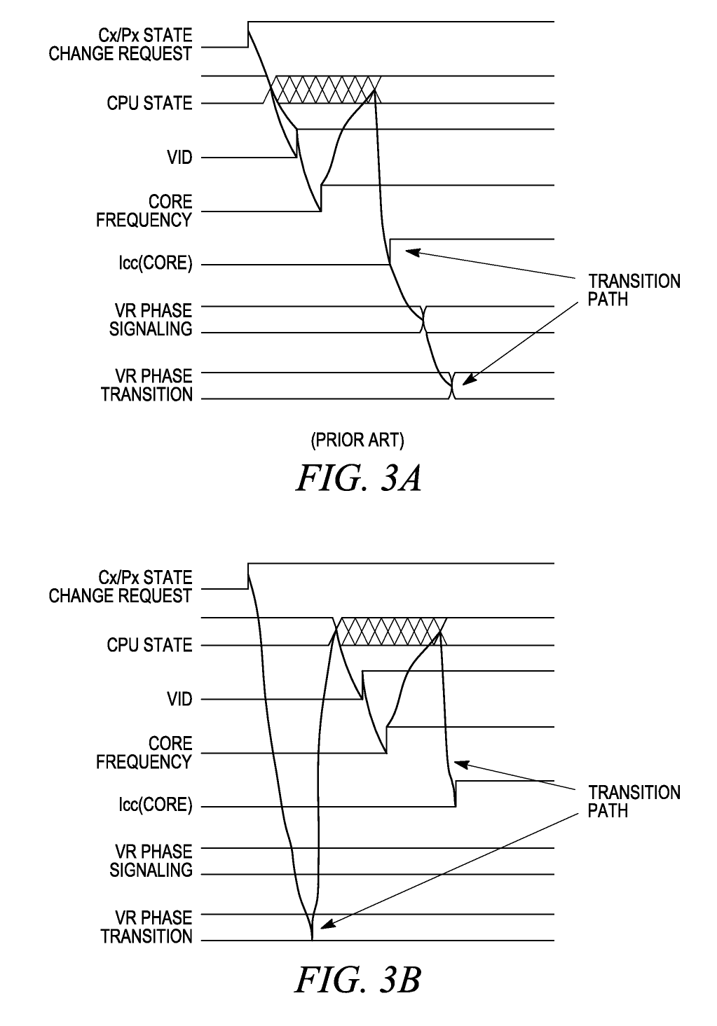

The VR interface 104 determines that the CPU, by way of the PCU, is to transition to a different power state, e.g., a higher or lower power state. In some embodiments, the VR is set to a proper power state (or “mode of operation”) before the PCU “releases” the CPU to transition to the next CPU power state e.g., (Px or Cx state). (This is illustrated in the example of FIG. 3B.) In addition, any change or transition of VR mode-of-operation can be controlled and adjusted intelligently on-the-fly to meet a desire of certain product requirements or a specific application usage mode. For example, the VR interface may determine that the next higher state does not require a higher VR operating mode, e.g., because its worse-case current can be tolerated by the VR's current (present) mode or because the state will occur briefly enough not to pose a threat of damage to the VR or result in increased overall efficiency.

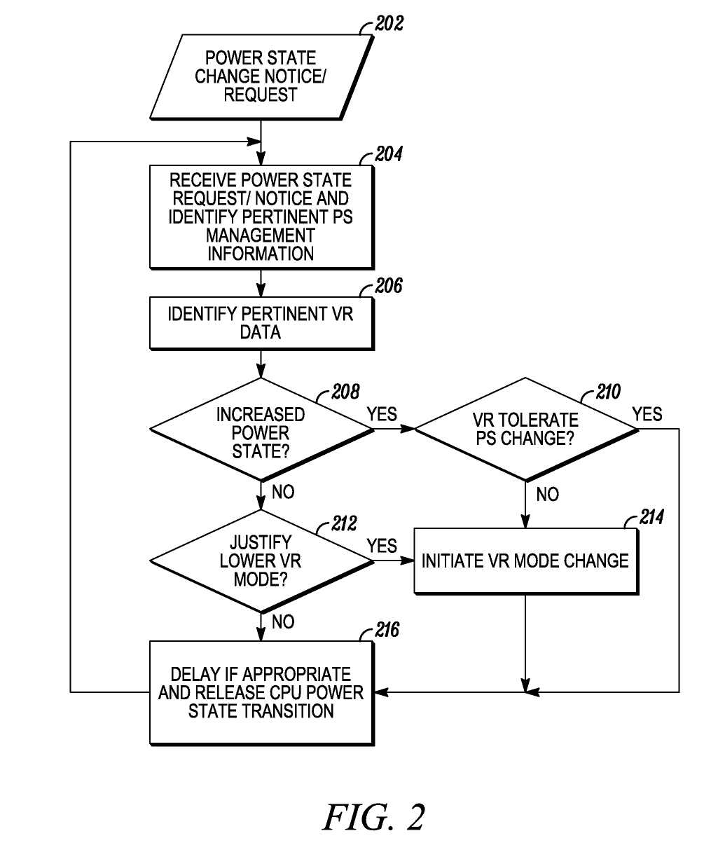

FIG. 2 is a flow diagram showing a routine for implementing a VR interface in accordance with some embodiments. At 202, a power state change notice or request is made, e.g., from the PCU. At 204, the VR interface receives (or perceives) the request. The interface identifies pertinent information for the requested next state. Such information may include possible current range for the power state, the amount of time (e.g., estimate if available) that the CPU will be in the next power state, upcoming expected states after the next power state, and the like.

At 206, the routine identifies pertinent VR data. This data includes present power mode data, e.g., pertaining to max. current, max. time under a max. current situation, and efficiency information relevant to the just-identified CPU power state information. At 208, the routine determines if the next power state is a higher power consuming state. If so, then at 210, it determines if the VR can tolerate the next, higher power state. This will depend on such factors as the maximum possible current in the next state and the expected or maximum amount of time that the CPU will be in the next power state. If the routine deems that the VR can tolerate the next state, then it proceeds to 216 where it releases the CPU (or PCU or equivalent) to enter into the next, higher state.

On the other hand, if at 210, it was determined that the VR's power mode should be adjusted (e.g., because it cannot handle the worse-case current demand), then at 214, a VR power mode change, to increase its power mode level, is initiated. From here, after a sufficient delay (if desired or appropriate), at 216, the interface releases the CPU to change its power state.

Returning back to 208, if the state change is not to a higher state, then by implication, it is a change to a lower state, so at 212, the routine determines if lowering the VR power mode is justified. For example, the interface may know (or infer) that the upcoming lower power state will have a small enough duration that switching losses in transitioning the VR to a lower state would offset any savings from being in a lower state. If it is justified, then at 214, the interface causes the VR to change power mode, i.e., go to a lower power mode. From here, the routine goes to 216 and releases the CPU (or PCU) to enter the next power state. If at 212, it was determined that the VR mode should not be changed, then the routine goes straight to 216 and releases the CPU to change state.

FIG. 3A is an event-timing diagram for a conventional platform. FIG. 3B is an event-timing diagram for a platform, in accordance with some embodiments, compared against the diagram of FIG. 3A. The diagrams illustrate transition paths showing how in the prior art scheme, the VR mode change is reactive to CPU load change. In contrast, FIG. 3B shows how with some inventive embodiments, VR change is proactive to CPU load change.

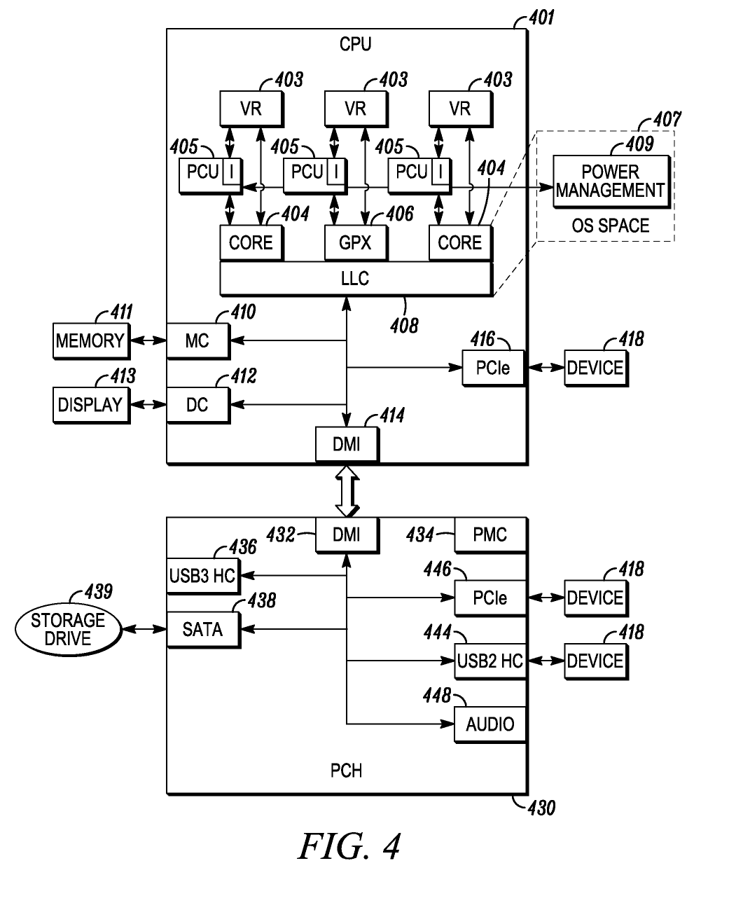

FIG. 4 is a diagram of a multi-core computing platform with a VR control interface in accordance with some embodiments. The depicted platform comprises a CPU chip 402 coupled to a platform control hub 430 via a direct media interconnect (DMI) interface 414/432. The platform also includes memory 411 coupled through a memory controller 410 and a display 413 coupled through a display controller 412. It also includes a storage drive 439 (e.g., a solid state drive) coupled through a drive controller such as the depicted SATA controller 438. It also includes devices 418 (e.g., network interface, WiFi interface, printer, camera, cellular network interface, etc.) coupled through platform interfaces such as PCI Express (416 in the CPU chip and 440 in the PCH chip) and USB interfaces 436, 444.

The CPU chip 401 comprises processor cores 404, a graphics processor 406, and last level cache (LLC) 408. One or more of the cores 404 execute operating system software (OS space) 407, which comprises a power management program 409.

At least some of the cores 404 and GPX 406 has an associated power control unit (PCU) 405 and VR 408 to supply it with power. Each PCU has a VR control interface (I) to negotiate power state changes in cooperation with its associated VR's power mode for its associated core. As indicated, each PCU is coupled to a power management program 409 that is implemented in the platform operating system for managing at least part of the platform's power management strategy. (Note that while in this embodiment, the power management program 409 is implemented with software in the OS, it could also or alternatively be implemented in hardware or firmware, e.g., in the CPU and/or PCH chip.)

In the preceding description and following claims, the following terms should be construed as follows: The terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not be in direct physical or electrical contact.

It should also be appreciated that in some of the drawings, signal conductor lines are represented with lines. Some may be thicker, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a diagram. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

It should be appreciated that example sizes/models/values/ranges may have been given, although the present invention is not limited to the same. As manufacturing techniques (e.g., photolithography) mature over time, it is expected that devices of smaller size could be manufactured. In addition, well known power/ground connections to IC chips and other components may or may not be shown within the FIGS, for simplicity of illustration and discussion, and so as not to obscure the invention. Further, arrangements may be shown in block diagram form in order to avoid obscuring the invention, and also in view of the fact that specifics with respect to implementation of such block diagram arrangements are highly dependent upon the platform within which the present invention is to be implemented, i.e., such specifics should be well within purview of one skilled in the art. Where specific details (e.g., circuits) are set forth in order to describe example embodiments of the invention, it should be apparent to one skilled in the art that the invention can be practiced without, or with variation of, these specific details. The description is thus to be regarded as illustrative instead of limiting.

What is claimed is:

1. An apparatus, comprising:
a control interface to control when power states are entered by a CPU based on characteristics of a VR supplying power to the CPU.

2. The apparatus of claim 1, in which the control interface is part of a power control unit in a CPU chip or can be a separate entity connecting to the CPU power control unit.

3. The apparatus of claim 1, in which the control interface is to receive an indication that a CPU power state change is to occur and it is to determine whether or not to change the VR power mode based on the state change.

4. The apparatus of claim 3, in which the control interface is to determine if the VR would run more efficiently for the new power state with a different VR power mode, and if so, to change the VR power mode.

5. The apparatus of claim 1, in which the control interface is to cause the VR to enter a different power mode before releasing the CPU power state.

6. The apparatus of claim 1, in which the VR is in the same chip as the CPU.

7. The apparatus of claim 1, in which the power control unit is to request the power state change to the control interface.

8. The apparatus of claim 7, in which the power control unit is to be implemented in a CPU chip comprising the CPU.

9. The apparatus of claim 8, in which the power control unit is to receive a command to change the CPU power state from a power management program in an operating system for the CPU.

10. A computer system, comprising:
a CPU chip comprising a plurality of cores;
wherein each core has an associated control interface coupled between an associated PCU and an associated VR to negotiate power state changes for the core in cooperation with power modes for its associated VR.

11. The system of claim 10, in which the VRs are part of the CPU chip.

12. The system of claim 10, in which each control interface is to cause its associated VR to stay in a current power mode if the power state change will last for a sufficiently small amount of time.

12. The system of claim 9, in which each control interface is to cause its associated VR to stay in a current power mode if the power state change is associated with operating currents within an acceptable range for the current VR power mode.

13. The system of claim 12, in which the control interface is to cause the VR power mode to change if the power state current range is outside of a threshold, the interface to cause the power mode to change before allowing the power state to be changed for the core.

14. The system of claim 10, comprising a power management program to control the PCUs for the cores.

15. The system of claim 14, in which the power management program is implemented in an operating system for the cores.

16. An apparatus, comprising:
a core to be in a power state;
a VR to provide a controllable voltage to the core and to be in a power mode; and
a control interface to receive a request to change the core to a next power state and to determine the power mode for the VR from several different power mode options based on parameters associated with the next power state.

17. The apparatus of claim 16, in which the control interface is to cause the VR to change to a different mode before allowing the next power state to be entered if it is to change the power mode.
